(19) United States
(12) Patent Application Publication
(10) Pub. No.: US 2012/0181306 A1
(43) Pub. Date: Jul. 19, 2012

(54) VALVE FOR DISPENSING A FLUID PRODUCT

(75) Inventors: Yvan Milian, Le Neubaug (FR); Christophe Jacuk, Le Vaudreuil (FR)

(73) Assignee: VALOIS SAS, Le Neubourg (FR)

(21) Appl. No.: 13/387,281

(22) PCT Filed: Jul. 26, 2010
(86) PCT No.: PCT/FR2010/051571

§ 371 Date: Apr. 4, 2012

(30) Foreign Application Priority Data
Jul. 30, 2009 (FR) 09 55357

(51) Int. Cl. B65D 83/54; B23P 11/00

(52) U.S. Cl. 222/402.2; 29/776; 29/428

(57) ABSTRACT

A fluid dispenser valve for mounting on a neck of a reservoir containing fluid, the valve having a valve body including a metering chamber, and a valve member that is movable in the metering chamber between a rest position and a dispensing position. The metering chamber includes an upper gasket and a lower gasket that co-operate in leaktight manner with the valve member. The valve includes a neck gasket that co-operates in leaktight manner with the valve body and with the receptacle neck, the valve body being made as a single piece. The neck gasket and said lower gasket are overmolded on the single-piece valve body.

The present invention provides a fluid dispenser valve and a fluid dispenser device including such a valve.

Fluid dispenser valves, in particular metering valves for dispensing pharmaceuticals in the form of aerosol sprays, are well known. They generally comprise a cylindrical valve body defining a metering chamber between two gaskets, an upper gasket and a lower gasket, and a valve member sliding in leaktight manner in said metering chamber between a rest position and a dispensing position. The valve body is fastened, in particular snap-fastened or crimped, in a cap, said cap being adapted to be crimped subsequently on the neck of a container containing the fluid to be dispensed. A neck gasket is interposed between the neck of the container and the cap so as to provide sealing at this connection. This type of valve functions in satisfactory manner, but presents a certain number of drawbacks. Thus, the number of component parts is large, thereby increasing the complexity of manufacture and of assembly, and thus increasing the cost of the valve. In particular, assembling the various valve gaskets is relatively complicated. In addition, the generally-metal spring of the valve is immersed in the fluid, and depending on the nature of the fluid, it may have undesirable effects on said fluid. In addition, valve bodies generally extend towards the inside of the reservoir on which they are assembled, thereby creating a dead volume, in particular for valves that are used upsidedown. The dead volume should generally be limited by adding a ring, known as a can end, that is assembled around said valve body. This means yet another part to manufacture and to assemble. In addition, the valve members are generally formed of two parts that are assembled together one in the other, thereby complicating still further the manufacture and the assembly of the valve.

Document WO 01/66439 describes a two-part valve body with a gasket interposed between said valve-body portions. Documents EP-1 336 822, FR-2 850 165, WO 01/79079, and U.S. Pat. No. 3,128,924 describe other prior-art devices.

An object of the present invention is to provide a simplified valve that does not have the above-mentioned drawbacks.

In particular, an object of the present invention is to provide a fluid dispenser valve comprising fewer component parts and fewer assembly steps.

Another object of the present invention is to provide a fluid dispenser valve that is simple and inexpensive to manufacture and to assemble.

The present invention thus provides a fluid dispenser valve for mounting on a neck of a reservoir containing fluid, said valve comprising a valve body including a metering chamber, and a valve member that is movable in said metering chamber between a rest position and a dispensing position, said metering chamber including an upper gasket and a lower gasket that co-operate in leaktight manner with said valve member, said valve including a neck gasket that co-operates in leaktight manner with said valve body and with said receptacle neck, said valve body being made as a single piece, said neck gasket and said lower gasket being overmolded on the single-piece valve body.

Advantageously, said neck gasket and said lower gasket are made out of the same material, in particular a thermoplastic elastomer.

Advantageously, said neck gasket and said lower gasket form a single piece.

Advantageously, said upper gasket is also overmolded on said valve body.

Advantageously, said lower gasket forms a lip that extends radially inwards and axially towards the reservoir, and that co-operates in leaktight manner with the valve member in the rest and dispensing positions.

Advantageously, said valve member is made as a single piece.

Advantageously, said valve member is movable in said valve between a rest position in which the metering chamber is isolated in leaktight manner from the reservoir and from the atmosphere, and a dispensing position in which the metering chamber is isolated in leaktight manner from the reservoir and is connected to the atmosphere via the valve member, said valve member including a filling position between said rest and dispensing positions, and in which said metering chamber is isolated from the atmosphere and is connected to said reservoir so as to fill the metering chamber.

Advantageously, said valve member includes a filling passage that connects said metering chamber to said reservoir in the filling position.

Advantageously, the valve member is urged towards its rest position by a spring that is isolated from the fluid in all positions.

Advantageously, said valve member includes a central axial channel that is connected at one end to an outlet orifice, and at the other end to a radial channel that opens out into the metering chamber in the dispensing position, said valve member including an outer radial shoulder, said spring being arranged around the valve member and co-operating with said radial shoulder so as to urge the valve member towards its rest position, said spring being arranged around said radial channel in the rest position.

The present invention also provides a fluid dispenser device comprising a reservoir containing fluid and a valve as described above.

Advantageously, said valve is assembled on the neck of the reservoir by means of a fastener cap that is provided with an axial extension that defines the opening through which the valve member can pass, said axial extension receiving the spring of the valve.

Advantageously, said valve body is fastened, in particular snap-fastened, inside the fastener cap.

The present invention also provides a method of manufacturing a device as described above, said method including the step of overmolding the lower gasket and the neck gasket on the single-piece valve body.

Advantageously, said gaskets are made out of the same thermoplastic-elastomer material, and are overmolded in a single overmolding step.

Advantageously, the method further includes the steps of assembling the valve member and the spring in the cap, then of fastening, in particular snap-fastening, the valve body in said cap.

Advantageously, said upper gasket is pre-assembled on said valve member so as to assemble it.

In a variant, said upper gasket is pre-assembled on said valve body so as to assemble it.

These characteristics and advantages and others of the present invention appear more clearly from the following detailed description thereof, given by way of non-limiting example, and with reference to the accompanying drawings, in which:

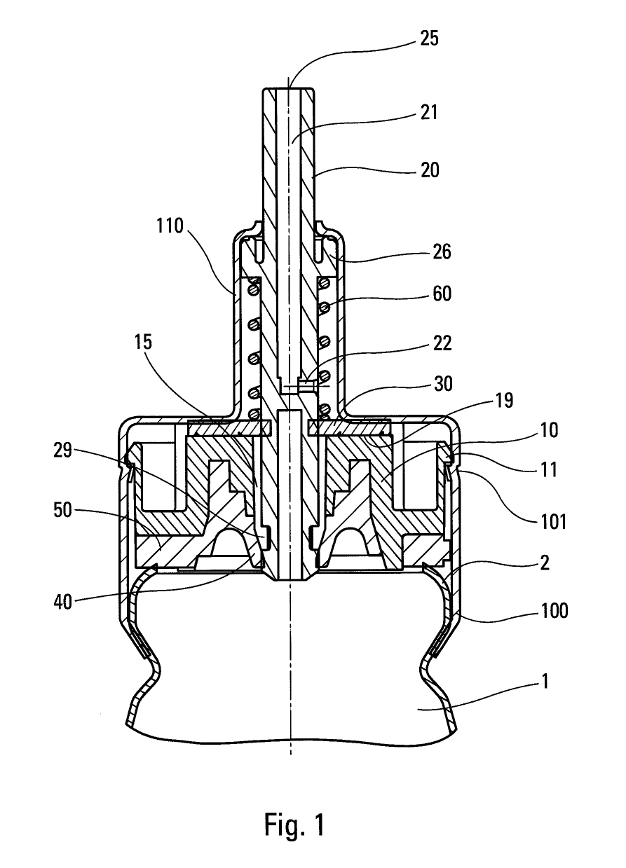

FIG. 1 is a diagrammatic section view showing a valve in a first advantageous embodiment of the present invention, in the rest position;

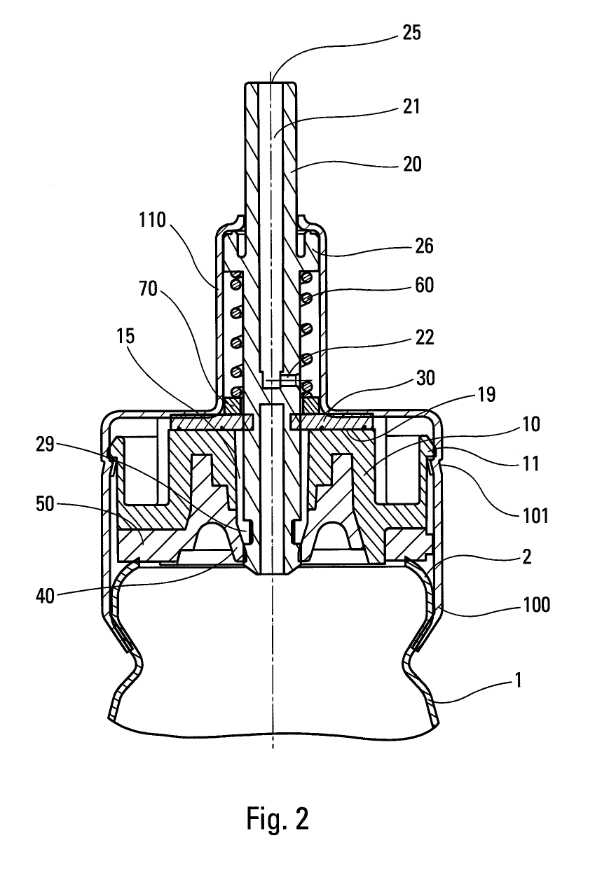

FIG. 2 is a view similar to the view in FIG. 1, showing a second advantageous embodiment of the present invention;

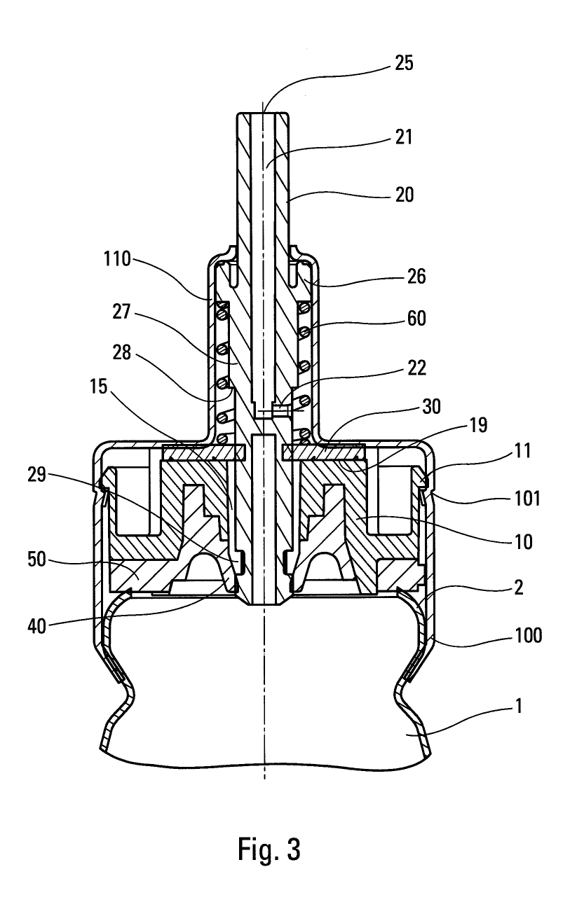

FIG. 3 is a view similar to the view in FIG. 1, showing a third advantageous embodiment of the present invention; and

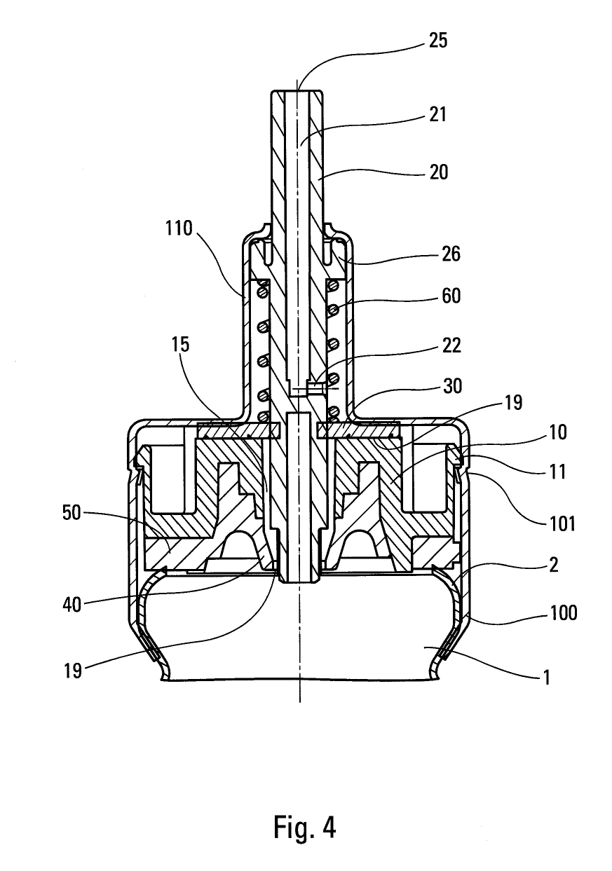

FIG. 4 is a view similar to the view in FIG. 1, showing a fourth advantageous embodiment of the present invention.

With reference in particular to FIG. 1, the present invention relates in particular to a valve of the metering-valve type for dispensing medication in aerosol form by means of a propellant gas. Naturally, the present invention may also apply to valves of another type or may be used in different fields, such as perfumery or cosmetics.

The valve shown in FIG. 1 includes a valve body 10 including a metering chamber 15. A valve member 20 is slidably mounted in the metering chamber 15 between a rest position shown in FIG. 1, and a dispensing position in which the valve member is pressed axially towards the inside of the valve. The valve member 20 is urged towards its rest position by a spring 60 that is compressed when a user actuates the valve and pushes the valve member axially inside the valve. When the user relaxes the actuation force, the compressed spring 60 returns the valve member 20 from its dispensing position to its rest position. The valve member includes a central axial channel 21 that opens out at one end to an axial outlet orifice 25, and at the other end into a radial channel 22 that opens out into the metering chamber 15 when the valve member 20 is in the dispensing position. The metering chamber 15 includes an upper gasket 30 and a lower gasket 40 (the expressions “upper” and “lower” being relative to the upright position of the valve shown in the figure), and the valve member 20 slides in leaktight manner against the upper and lower gaskets 30, 40.

The valve body 10 is assembled on a reservoir 1, in particular on the neck 2 of the reservoir 1, by means of a fastener member 100 that is advantageously a crimping cap, as shown in the figure. In this embodiment, it should be observed that the fastener member could be of a different type, e.g. screw-fastenable, snap-fastenable, or the like. A neck gasket 50 is interposed between the valve body 10 and the fastener member 100 which, for the purpose of simplicity of description, is referred to below as a fastener cap, said neck gasket 50 providing sealing between the valve body 10 and the neck 2 of the reservoir 1.

In an aspect of the invention, the neck gasket 50 and the lower gasket 40 of the metering chamber are overmolded on said valve body 10. Advantageously, the gaskets are made out of the same material.

Advantageously, the gasket(s) is/are made out of olefin-based thermoplastic polyester elastomer (TPE) material, e.g. a mixture of polypropylene (PP) and styrene-block copolymer (SBC); poly(ethylene octene) (PEO); poly(ethylene butene) (PEB); ethyl vinyl acetate (EVA); a mixture of PP and ethylene propylene diene monomer (EPDM). The gaskets are overmolded on the valve body 10, advantageously in a single overmolding step. The valve body 10 is made as a single piece, which makes it simpler to manufacture and to assemble. Advantageously, the valve body is made out of polyolefin that favors the overmolding of gaskets made out of olefin-based TPE, as a result of the chemical affinity of said materials. Advantageously, the molding of the valve body made out of polyolefin, and the overmolding of gaskets made out of olefin-based TPE, are performed in the same mold. Other possible materials for the valve body include: polybutylene terephthalate (PBT); polyoxymethylene (POM); polyamide (PA); polycarbonate (PC); polymethyl methacrylate (PMMA); polyvinyl chloride (PVC); acrylonitrile butadiene styrene (ABS); PP; polyethylene (PE); and alloys of all of these materials. Other possible materials for the gasket(s) include: thermoplastics alloys (nitrile butadiene rubber (NBR)/PP, butyl/PP, halobutyl/PP, hydrogenated nitrile butadiene rubber (HNBR)/PE); thermoplastic elastomers prepared by dynamic vulcanization; thermoplastic polyamide elastomers (polyether block amide (PEBA), polyesteramide (PEA), polyetheresteramide (PEEA), polycarbonate-esteramide (PLEA)); thermoplastic polyether ester elastomers; thermoplastic polyurethane elastomers (TPU); styrene-block copolymers (styrene-butadiene-styrene (SBS), styrene-isoprene-styrene (SIS), styrene-ethylene-butylene-styrene (SEBS), styrene-ethylene-propylene-styrene (SEPS), styrene-ethylene-ethylene-propylene-styrene (SEEPS), styrene-isoprene-butadiene-styrene (SIBS)); and mixtures of any of these materials.

Advantageously, the neck gasket 50 forms a single piece with the lower gasket 40, as can be seen in FIG. 1. The present invention thus makes it possible to eliminate component parts and to simplify the assembly of the valve, since, once the gaskets have been overmolded, the unit formed by the valve body 10 and the gaskets 30, 40 is fastened in the crimping cap 100 in a single assembly step. Advantageously, such fastening is performed by snap-fastening the valve body 10, in particular a radially-outer snap-fastener portion 11 of the valve body 10, onto a corresponding snap-fastener shoulder 101 of the fastener cap 100. By way of example, the snap-fastener shoulder 101 may be made by stamping. The upper gasket 30 made out of elastomer or out of TPE may be made in the form of a flat gasket that is pre-assembled on the valve member 20 or on the valve body 10. Advantageously in this configuration, axial ribs 19 are provided on the portion of the valve body that receives said upper gasket 30. In a variant, the upper gasket 30 could also be overmolded on the valve body. The three gaskets could thus be formed as a single piece that is overmolded on the valve body in a single overmolding step.

In another advantageous aspect, the lower gasket 40 may be formed of a lip so as to provide sealing. The lip extends axially downwards and radially inwards, as can be seen in FIG. 1, and it is urged radially against the valve member 20. This implementation guarantees good sealing. In addition, after being overmolded on the valve body 10, the lower gasket 40 advantageously forms, at least in part, the bottom edge of said unit made up of the valve body and of the overmolded gaskets. Thus, the closure of the reservoir 1 forms a surface that is approximately plane, eliminating, or in any event, significantly limiting the dead volume of fluid inside said reservoir. Thus, it is no longer necessary to provide a can-end ring, as with conventional valves.

In another aspect of the invention, the spring 60 of the valve is completely isolated from the fluid contained in the reservoir or in the valve, in particular so as to avoid any interaction between said fluid and the spring that is generally made of metal. Thus, as can be seen in FIG. 1, the cap 100 may include an axial extension 110 for housing said spring 60. The top end of the axial extension 110 defines the opening through which the valve member 20 can pass. The shoulder 26 of the valve member, pushed upwards axially by the spring in the rest position, co-operates with the top end of the axial extension 110 of the cap so as to define the rest position of the valve member and thus of the valve. The spring 60 co-operates at one end with a radial shoulder 26 of the valve member 20. Advantageously, said shoulder 26 presents an axial length that is long enough to effectively guide the top of the valve member during actuation. At the other end, and by way of example, the spring 60 may bear on said upper gasket 30. This implementation also makes the valve simpler to assemble. Thus, the valve member 20 is inserted into the cap 100 together with the spring 60 that is put into place around said valve member 20, in contact with said shoulder 26, and then the unit made up of the valve body and the gaskets is snap-fastened in the cap 100. The valve is thus assembled and ready to be fastened on a reservoir filled with the fluid for dispensing.

FIG. 2 shows another embodiment in which an O-ring or washer 70 is interposed between the gasket 30 and the spring 60, so as to avoid potentially-negative interactions between the spring and the gasket, such as deformation of said gasket. The O-ring enables spring stresses to be distributed better. The O-ring 70 is also used during filling, while the fluid is being injected at high pressure through the valve member, which may cause deformation of the gasket 30 because of the sudden increase in pressure in the metering chamber 15. The presence of an O-ring 70 prevents such deformation.

FIG. 3 shows another variant embodiment in which the valve member includes splines or fluting 27 between the shoulder 26 and the gasket 30, which splines or fluting, when in the actuated position, and thus also when in the filling position, come, via their bottom front radial surfaces 28, to bear against the gasket 30, in particular so as to avoid it deforming during filling.

In still another advantageous aspect, the valve member 20 is made as a single piece, and the metering chamber 15 is isolated from the reservoir by the lower gasket 40, both in the rest position and in the dispensing position. It is only when the valve member 20 moves between its rest and dispensing positions, in a position known as the filling position, that the metering chamber 15 is connected to the reservoir, so as to enable it to be filled. In this respect, the valve member 20 includes at least one filling passage 29 that connects the metering chamber 15 to said fluid reservoir in the filling position of the valve member, the filling position being situated between the dispensing position and the rest position. More particularly, the metering chamber 15 is advantageously closed in leaktight manner in the rest position of the valve member 20, in such a manner that the lower gasket 40 closes the filling passage 29 in leaktight manner when the valve member 20 is in the rest position. Thus, there is no risk of the fluid contained in the metering chamber 15 being lost when the valve member is in the rest position, since the metering chamber 15 is completely isolated. Thus, the lower gasket 40 co-operates with the valve member 20 so as to close the filling passage 29 in leaktight manner, both in the rest position and in the dispensing position of the valve member.

Advantageously, the filling passage 29 is made by means of one or more lateral channels formed in the side wall of the valve member 20. In particular, filling is dependent on the depth and on the height of the filling passage 29. After expelling a dose, the valve member 20 returns automatically to its rest position under the effect of the spring 60. When the valve member 20 arrives in the filling position, the lower gasket 40 no longer co-operates in leaktight manner with the valve member 20, but is situated level with the lateral channel(s) formed in said valve member 20. Depending on the dimensions and on the depth of the passage and on the number of channels, filling takes place at a faster or a slower rate, and the quantity of the dose to be transferred into the metering chamber 15 determines the dimensions of the lateral passage(s) 29. The suction created in the metering chamber 15 after the preceding dose has been expelled may lead to a new dose being filled while the valve member 20 is passing via its filling position during its return movement towards its rest position. During a subsequent actuation, the valve member 20 once again passes via its filling position prior to reaching its dispensing position, such that if the dose in the metering chamber 15 happens to be incomplete, it will be topped up during this actuation. Obviously, it is preferable to make the lateral channel(s) in such a manner that the metering chamber 15 is filled totally and completely, so that it is guaranteed that the dose is completely reproducible.

FIG. 4 shows another embodiment in which the lower gasket does not isolate the metering chamber 15 in the rest position. In this configuration, the filling passage 29 may be replaced by one or more grooves 19 that enable the metering chamber 15 to fill rapidly when the valve is turned upsidedown during the filling of the chamber by pressure difference, and to empty slowly when the valve is in the upright rest position in FIG. 4 with equal pressures between the can and the chamber.

Although the present invention is described above with reference to several distinct embodiments, naturally the various characteristics shown in the various figures could be combined together in any manner. In addition, certain aspects described above could be implemented independently. For example, complete isolation of the return spring from the fluid could be envisaged, with the neck gaskets, upper gasket, and lower gasket being made differently. In addition, the sealing lip forming the lower gasket could also be made independently of the upper gasket and of the neck gasket, and independently of the overmolding.

In addition, any useful modification could be applied thereto by a person skilled in the art, without going beyond the ambit of the present invention, as defined by the accompanying claims.

1. A fluid dispenser valve for mounting on a neck of a reservoir containing fluid, said valve comprising a valve body including a metering chamber, and a valve member that is movable in said metering chamber between a rest position and a dispensing position, said metering chamber including an upper gasket and a lower gasket that co-operate in leaktight manner with said valve member, said valve including a neck gasket that co-operates in leaktight manner with said valve body and with said receptacle neck, said valve being characterized in that said valve body is made as a single piece, and in that said neck gasket and said lower gasket are overmolded on the single-piece valve body.

2. A valve according to claim 1, wherein said neck gasket and said lower gasket are made out of the same material, in particular a thermoplastic elastomer.

3. A valve according to claim 1, wherein said neck gasket and said lower gasket form a single piece.

4. A valve according to claim 1, wherein said upper gasket is also overmolded on said valve body.

5. A valve according to claim 1, wherein said lower gasket forms a lip that extends radially inwards and axially towards the reservoir, and that co-operates in leaktight manner with the valve member in the rest and dispensing positions.

6. A valve according to claim 1, wherein said valve member is made as a single piece.

7. A valve according to claim 1, wherein said valve member is movable in said valve between a rest position in which the metering chamber is isolated in leaktight manner from the reservoir and from the atmosphere, and a dispensing position in which the metering chamber is isolated in leaktight manner from the reservoir and is connected to the atmosphere via the valve member said valve member including a filling position between said rest and dispensing positions, and in which said metering chamber is isolated from the atmosphere and is connected to said reservoir so as to fill the metering chamber.

8. A valve according to claim 7, wherein said valve member includes a filling passage that connects said metering chamber to said reservoir in the filling position.

9. A valve according to claim 1, wherein the valve member is urged towards its rest position by a spring that is isolated from the fluid in all positions.

10. A valve according to claim 9, wherein said valve member includes a central axial channel that is connected at one end to an outlet orifice, and at the other end to a radial channel that opens out into the metering chamber in the dispensing position, said valve member including an outer radial shoulder, said spring being arranged around the valve member and co-operating with said radial shoulder so as to urge the valve member towards its rest position, said spring being arranged around said radial channel in the rest position.

11. A fluid dispenser device comprising a reservoir containing fluid, said device being characterized in that it further comprises a valve according to any preceding claim.

12. A device according to claim 11, wherein said valve is assembled on the neck of the reservoir by means of a fastener cap that is provided with an axial extension that defines the opening through which the valve member can pass, said axial extension receiving the spring of the valve.

13. A device according to claim 11, wherein said valve body is fastened, in particular snap-fastened, inside the fastener cap.

14. A method of manufacturing a device according claim 11, said method being characterized in that it includes the step of overmolding the lower gasket and the neck gasket on the single-piece valve body.

15. A method according to claim 14, wherein said gaskets are made out of the same thermoplastic-elastomer material, and are overmolded in a single overmolding step.

16. A method according to claim 14, further including the steps of assembling the valve member and the spring in the cap, then of fastening, in particular snap-fastening, the valve body in said cap.

17. A method according to claim 16, wherein said upper gasket is pre-assembled on said valve member so as to assemble it.

18. A method according to claim 16, wherein said upper gasket is pre-assembled on said valve body so as to assemble it.
